(19) United States
(12) Patent Application Publication
(10) Pub. No.: US 2019/0118350 A1
(43) Pub. Date: Apr. 25, 2019

(54) RATCHET WRENCH

(71) Applicant: AFICIAL CO., LTD., Taichung (TW)

(72) Inventor: HSIEH-LIN LIAO, TAICHUNG (TW)

(21) Appl. No.: 15/792,916

(22) Filed: Oct. 25, 2017

(51) Int. Cl. B25B 13/46

(52) U.S. Cl. CPC B25B 13/463; B25B 23/0035

(57) ABSTRACT

A ratchet wrench includes a main body, a ratchet, two detents, two elastic members, and a switch knob. The strength of the material of the detents is greater than that of the material of the ratchet. During the process of operating the ratchet wrench, if the applied force is greater than the limit torsional force of the meshing portion between the teeth of the ratchet and the toothed portion of the detent to damage the teeth of the ratchet, the toothed portion of the detent will be instantly engaged with the intact teeth of the ratchet, located behind the damaged teeth, to be positioned again, thereby ensuring the safety of the operator.

### FIELD OF THE INVENTION

The present invention relates to a ratchet wrench, and more particularly, to a ratchet wrench that is able to ensure the safety of the operator if the operator applies a force greater than the limit torsional force of the meshing portion between the teeth of a ratchet and the toothed portion of a detent.

### BACKGROUND OF THE INVENTION

As shown in FIG. 1 to FIG. 5, a conventional ratchet wrench comprises a main body 2, a ratchet 3, two detents 4, a switch knob 5, two elastic members 6, and a lid 7.

The main body 2 has a head portion 21 and a handle portion 22. The head portion 21 extends from one end of the handle portion 22. The head portion 21 has a first accommodation trough 211 and a second accommodation trough 212 communicating with the first accommodation trough 211. The first accommodation trough 211 and the second accommodation trough 212 penetrate through two sides of the head portion 21. The first accommodation trough 211 and the second accommodation trough 212 have a connecting portion 213 at one side of the head portion 21. The wall of the second accommodation trough 212 is provided with a pair of pivot grooves 214 opposite the first accommodation trough 211. The other side of the head portion 21, opposite the connecting portion 213, has an engaging groove 215. The connecting portion 213 is provided with two perforations 216.

The ratchet 3 is disposed in the first accommodation trough 211 of the main body 2. The periphery of the ratchet 3 is provided with a plurality of teeth 31. One end of the ratchet 3 has a coupling portion 32 for engaging with or disengaging from a socket (a conventional component, not shown).

The two detents 4 are arranged symmetrically left and right. The two detents 4 are disposed in the head portion 21 of the main body 2. The two detents 4 each have one end pivotally connected to the pair of pivot grooves 214 of the main body 2 and another end formed with a toothed portion 41 corresponding to the teeth 31 of the ratchet 3.

The switch knob 5 is pivotally connected to the second accommodation trough 212 of the main body 2 and is rotatable for selectively pushing one of the two detents 4 to disengage the toothed portion 41 of the detent 4 from the teeth 31 of the ratchet 3. The switch knob 5 has an operation portion 51 and a pillar portion 52. The pillar portion 52 extends vertically from one end of the operation portion 51. A cylindrical sleeve portion 53 is provided between the pillar portion 52 and the operation portion 51. The pillar portion 52 is substantially triangular in shape. The pillar portion 52 has a first side 521, a second side 522, and a contact side 523. The contact side 523 is connected between the first side 521 and the second side 522. The first side 521 and the second side 522 are disposed at an acute angle to the contact side 523. The contact side 523 is a curved side. A distal end of the pillar portion 52 is formed with a screw hole 54.

The two elastic members 6 each have one end leaning against the side wall surface of the second accommodation trough 212 of the main body 2 and another end leaning against a corresponding one of the detents 4 for the toothed portion 41 of the detent 4 to mesh with the teeth 31 of the ratchet 3.

The lid 7 has a through hole 71 at one end thereof and a mounting hole 72 at another end thereof. Two screws 73 are inserted through the two perforations 216 of the connecting portion 213 and screwed to threaded holes 74 of the lid 7. The lid 7 is configured to cover the engaging groove 215 to seal the aforesaid components in the head portion 21. The coupling portion 32 of the ratchet 3 is inserted through the through hole 71 and exposed to the outside. A bolt 75 is inserted through the mounting hole 72 and locked to the screw hole 54 of the switch knob 5 so that the switch knob 5 is positioned. An elastic washer 76 is provided between the engaging groove 215 and the lid 7 so that the lid 7 is secured to the engaging groove 215 tightly and won't be easily loosened.

Through the assembly of the above-described structure, the rotational direction of the ratchet 3 can be switched by turning the operation portion 51 of the switch knob 5. When the operation portion 51 is turned to the right, the left and right detents 4 are pushed by the contact side 523 of the pillar portion 52. The right detent 4 is moved away from the ratchet 3 and the left detent 4 meshes with the ratchet 3, so that the ratchet 3 can be turned clockwise in a unidirectional direction. On the contrary, when the operation portion 51 is turned to the left, the left and right detents 4 are pushed by the contact side 523 of the pillar portion 52. The right detent 4 meshes with the ratchet 3 and the left detent 4 is moved away from the ratchet 3, so that the ratchet 3 can be turned counterclockwise in a unidirectional direction.

Accordingly, the operator can switch the rotational direction of the ratchet 3 through the operation portion 51 of the switch knob 5. The coupling portion 32 of the ratchet 3 is used to engage with or disengage from a socket. The socket is used to fit a workpiece (not shown), so that the workpiece can be tightened or loosened by applying a force.

During the process of operating the handle portion 22 of the main body 2 of the ratchet wrench, if the applied force is within the allowable range of the initial structural design of the ratchet wrench, the operation portion 51 of the switch knob 5 can be turned to switch the rotational direction of the ratchet 3 so that the teeth 31 of the ratchet 3 mesh with the tooth portion 41 of the left detent or the right detent, thereby enabling the coupling portion 32 of the ratchet 3 to engage with or disengage from a socket. The socket is used to fit a workpiece, so that the workpiece can be tightened or loosened by applying a force. As shown in FIG. 5, when the operator uses the ratchet wrench in cooperation with the socket to lock the workpiece, if the operator deems that the applied force is not enough to lock the workpiece, a sleeve may be connected to the rear end of the handle portion 22 of the main body 2 to extend the effort arm. As a result, the applied force may be greater than the limit torsional force of the meshing portion A between the teeth 31 of the ratchet 3 and the toothed portion 41 of the detent 4 to damage the teeth. Because the number of the teeth of the toothed portion 41 of the detent 4 is obviously less than that of the teeth 31 of the ratchet 3, the toothed portion 41 of the detent 4, meshed with the plurality of teeth 31 of the ratchet 3 at the meshing portion A is damaged, and the toothed portion 41 of the detent 4 slips with respect to the teeth 31 of the ratchet 3 so that the applied force loses the holding fulcrum on that moment. The ratchet 3 is idling at the original meshing portion A, which seriously affects the safety of the operator.

Accordingly, the inventor of the present invention has devoted himself based on his many years of practical experiences to solve these problems.

### SUMMARY OF THE INVENTION

In view of the shortcomings of the prior art, the primary object of the present invention is to provide a ratchet wrench that can ensure the safety of the operator if the operator applies a force greater than the limit torsional force of the meshing portion between the teeth of a ratchet and the toothed portion of a detent.

In order to achieve the aforesaid object, the ratchet wrench of the present comprises a main body, a ratchet, two detents, two elastic members, and a switch knob. The main body has a head portion. The head portion has a first accommodation trough and a second accommodation trough communicating with the first accommodation trough. A wall of the second accommodation trough is provided with a pair of pivot grooves opposite the first accommodation trough. The ratchet is disposed in the first accommodation trough. A periphery of the ratchet is provided with a plurality of teeth. The two detents each have one end pivotally connected to the pair of pivot grooves of the main body and another end formed with a toothed portion corresponding to the teeth of the ratchet. The two elastic members each have one end leaning against a side wall surface of the second accommodation trough of the main body and another end leaning against a corresponding one of the detents for the toothed portion of the corresponding detent to mesh with the teeth of the ratchet. The switch knob is pivotally connected to the second accommodation trough for selectively controlling and pushing one of the two detents to disengage the toothed portion of the detent from the teeth of the ratchet. The ratchet wrench is characterized in that the two detents are made of a material having a strength greater than that of a material of the ratchet.

During the process of operating the ratchet wrench, if the operator applies a force greater than the limit torsional force of the meshing portion between the teeth of the ratchet and the toothed portion of the detent, the teeth of the ratchet will be damaged. Since the strength of the material of the detent is greater than the strength of the material of the ratchet, the plurality of teeth located at the meshing portion of the ratchet and the detent will be damaged. When the toothed portion of the detent slips, the toothed portion of the detent will be instantly engaged with the intact teeth of the ratchet, located behind the damaged teeth, to be positioned again, thereby ensuring the safety of the operator.

### BRIEF DESCRIPTION OF THE DRAWINGS

FIG. 1 is an exploded view of a conventional ratchet wrench;

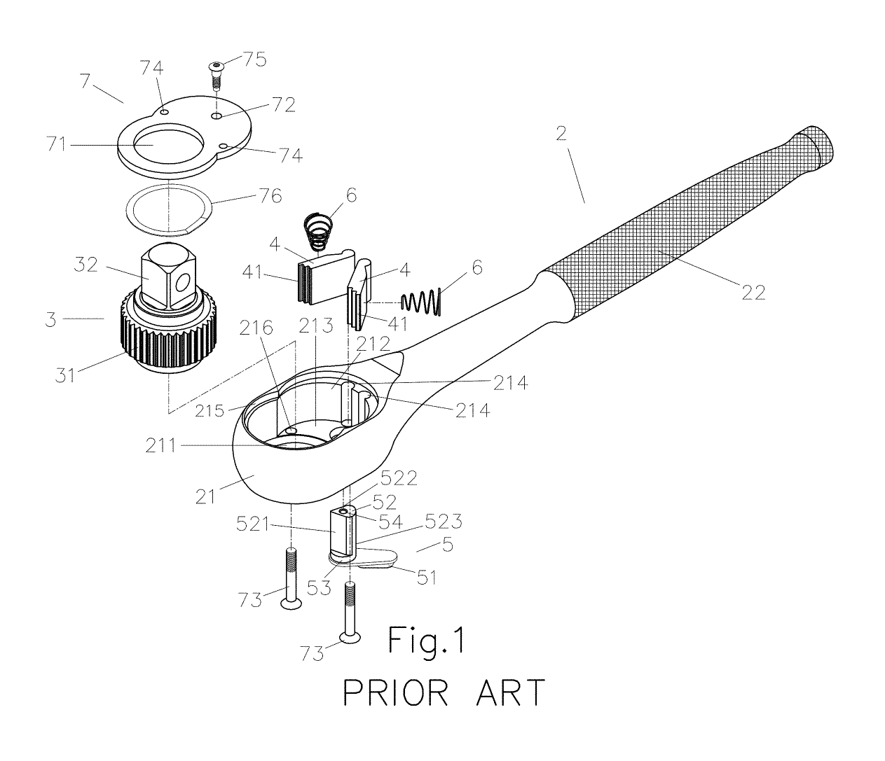

FIG. 2 is a perspective view of FIG. 1;

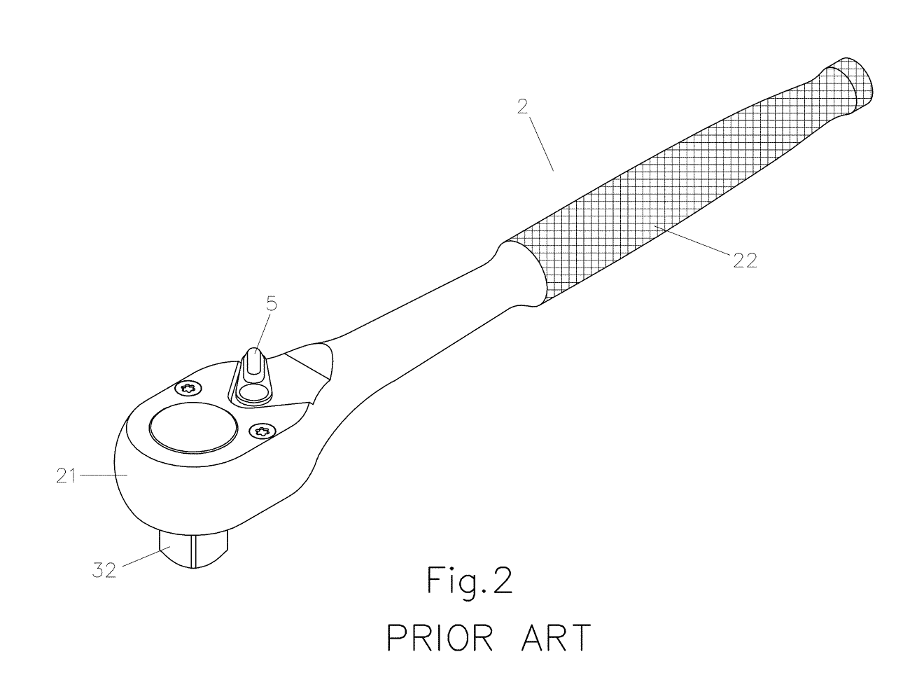

FIG. 3 is a partial sectional view of the conventional ratchet wrench, wherein the operation portion of the switch knob is turned to the right so that the ratchet can be turned clockwise;

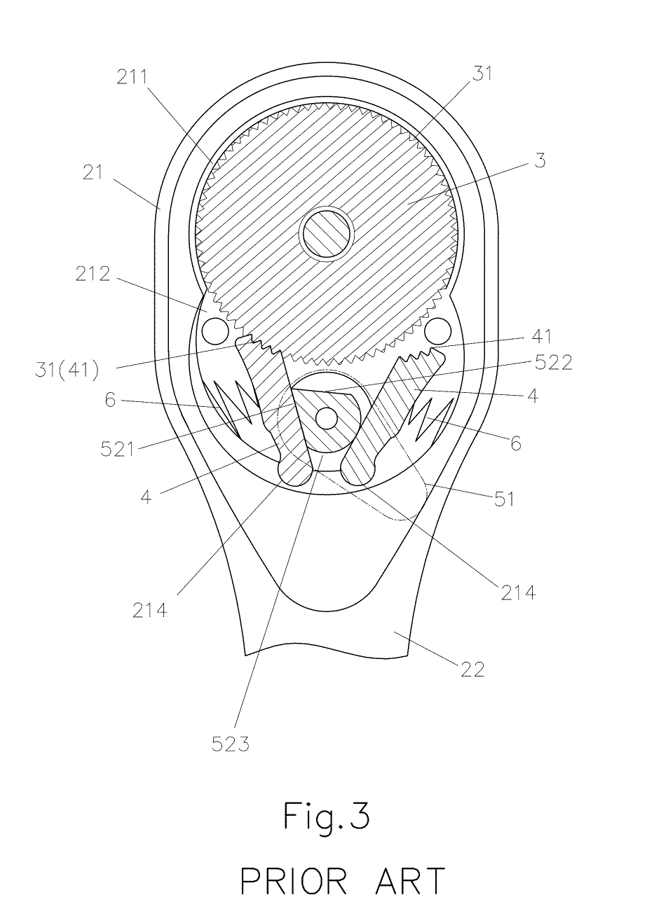

FIG. 4 is a partial sectional view of the conventional ratchet wrench, wherein the operation portion of the switch knob is turned to the left so that the ratchet can be turned counterclockwise;

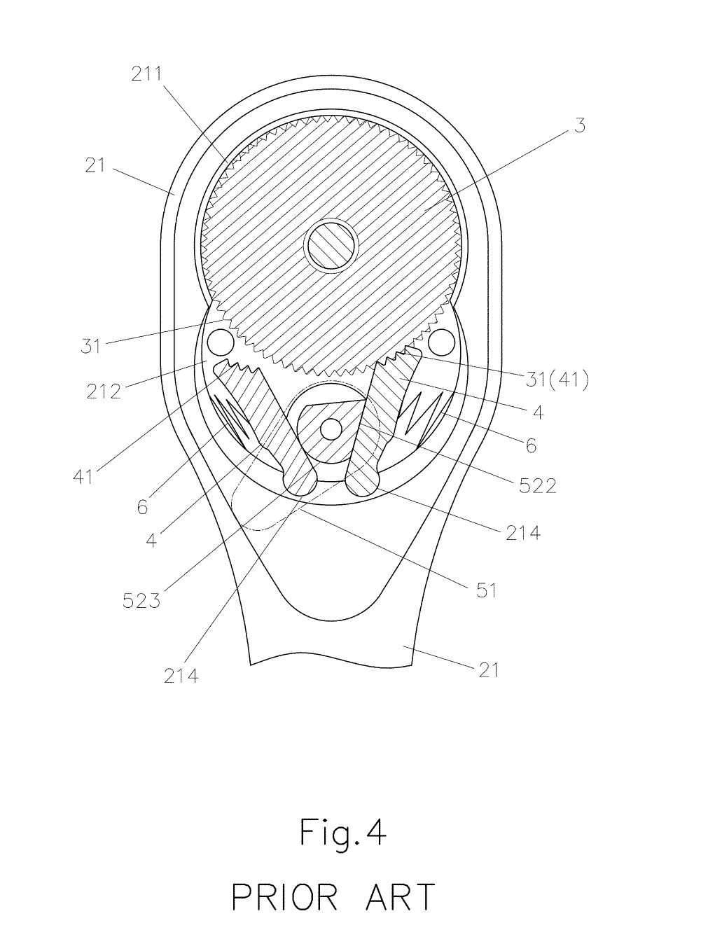

FIG. 5 is a partial sectional view of the conventional ratchet wrench, wherein the toothed portion of the detent is damaged because the operator applies an excessive force to the ratchet wrench;

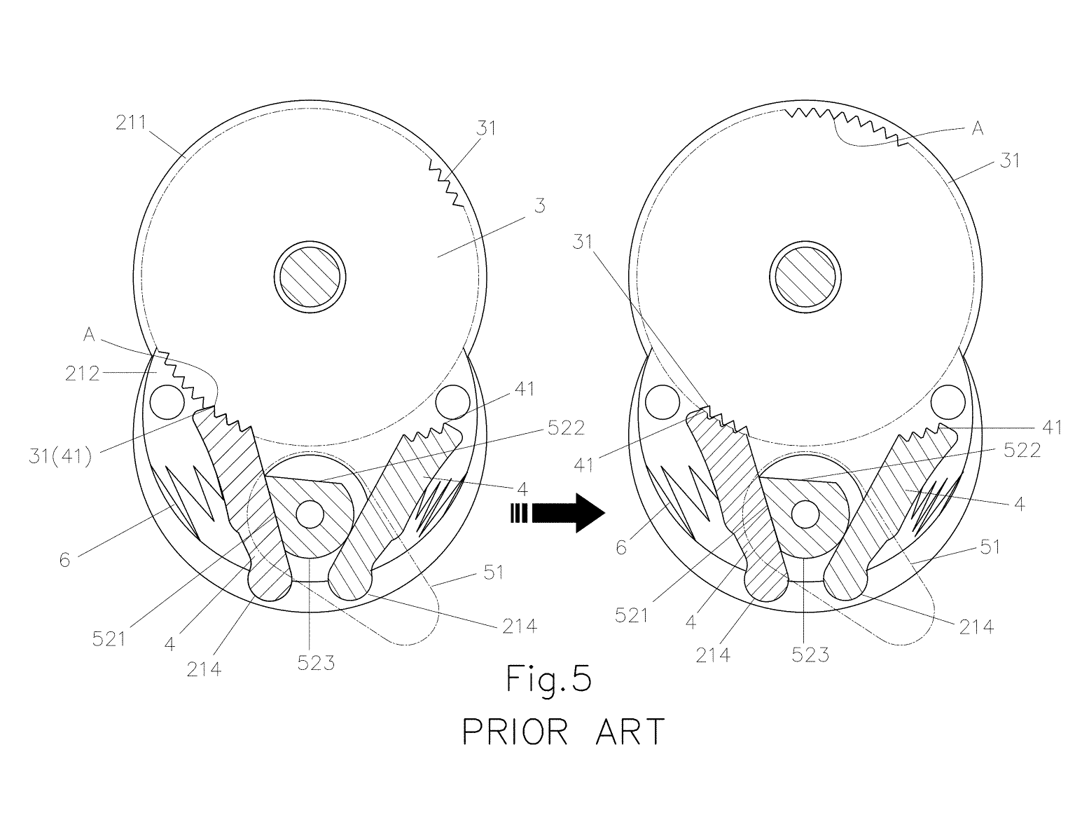

FIG. 6 is an exploded view of the ratchet wrench in accordance with a first embodiment of the present invention;

FIG. 7 is a perspective view of FIG. 6;

FIG. 8 is a partial sectional view of the ratchet wrench in accordance with the first embodiment of the present invention, wherein the operation portion of the switch knob is turned to the right so that the ratchet can be turned clockwise;

FIG. 9 is a partial sectional view of the ratchet wrench in accordance with the first embodiment of the present invention, wherein the operation portion of the switch knob is turned to the left so that the ratchet can be turned counterclockwise;

FIG. 10 is a partial sectional view of the ratchet wrench in accordance with the first embodiment of the present invention, wherein the teeth of the ratchet is damaged because the operator applies an excessive force to the ratchet wrench;

FIG. 11 is an exploded view of the ratchet wrench in accordance with a second embodiment of the present invention;

FIG. 12 is an enlarged view of the ratchet wrench in accordance with the second embodiment of the present invention;

FIG. 13 is a perspective view of FIG. 11;

FIG. 14 is a partial sectional view of the ratchet wrench in accordance with the second embodiment of the present invention, wherein the operation portion of the switch knob is turned to the right so that the ratchet can be turned clockwise;

FIG. 15 is a partial sectional view of the ratchet wrench in accordance with the second embodiment of the present invention, wherein the operation portion of the switch knob is turned to the left so that the ratchet can be turned counterclockwise; and

FIG. 16 is a partial sectional view of the ratchet wrench in accordance with the second embodiment of the present invention, wherein the teeth of the ratchet is damaged because the operator applies an excessive force to the ratchet wrench.

### DETAILED DESCRIPTION OF THE PREFERRED EMBODIMENTS

Embodiments of the present invention will now be described, by way of example only, with reference to the accompanying drawings.

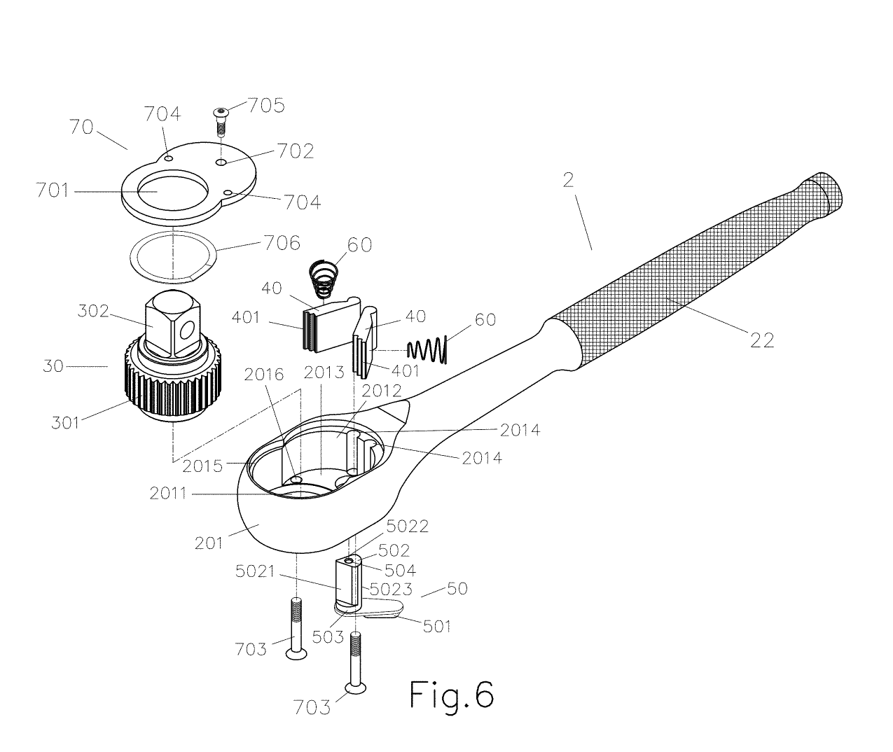

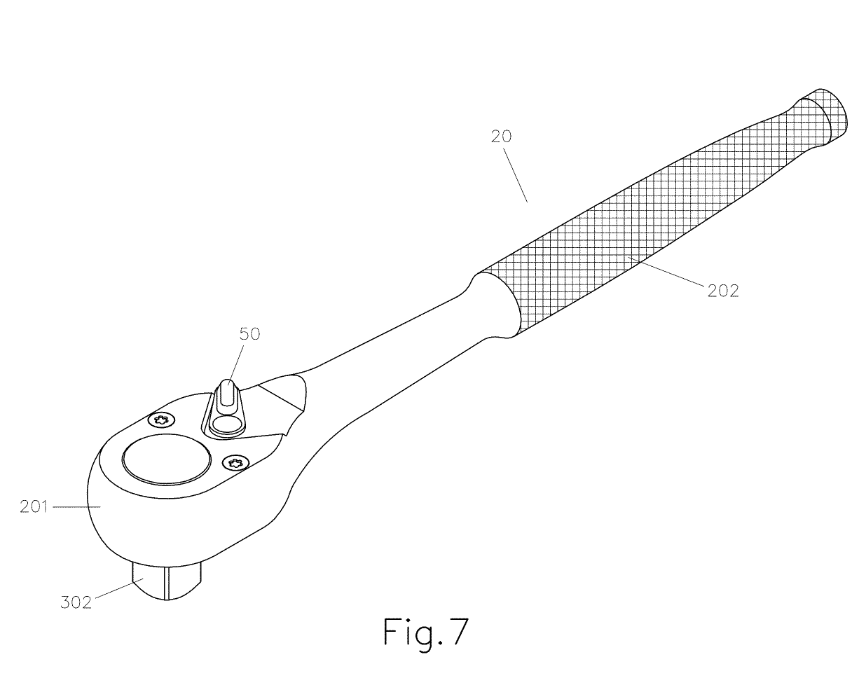

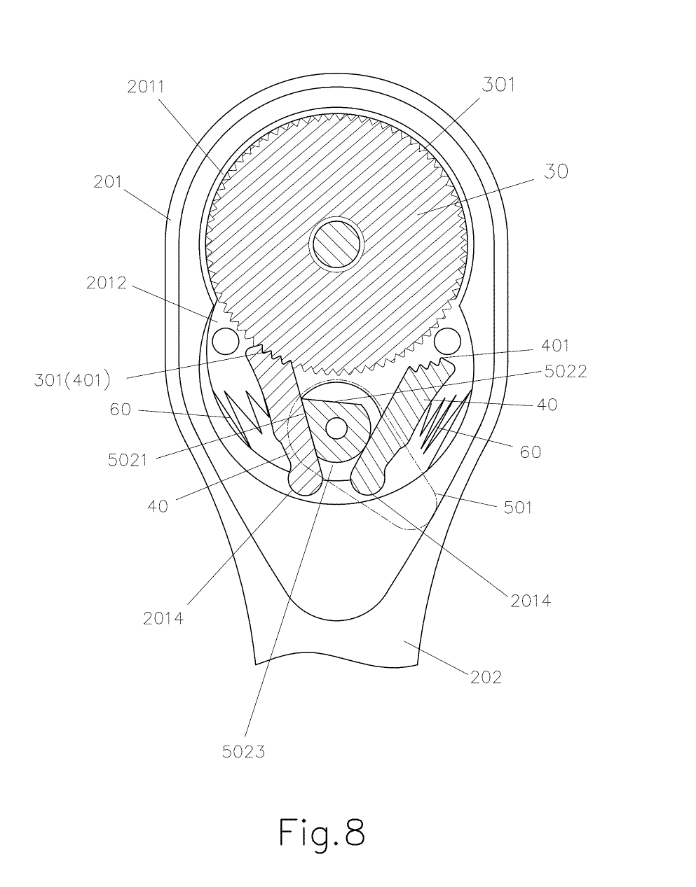

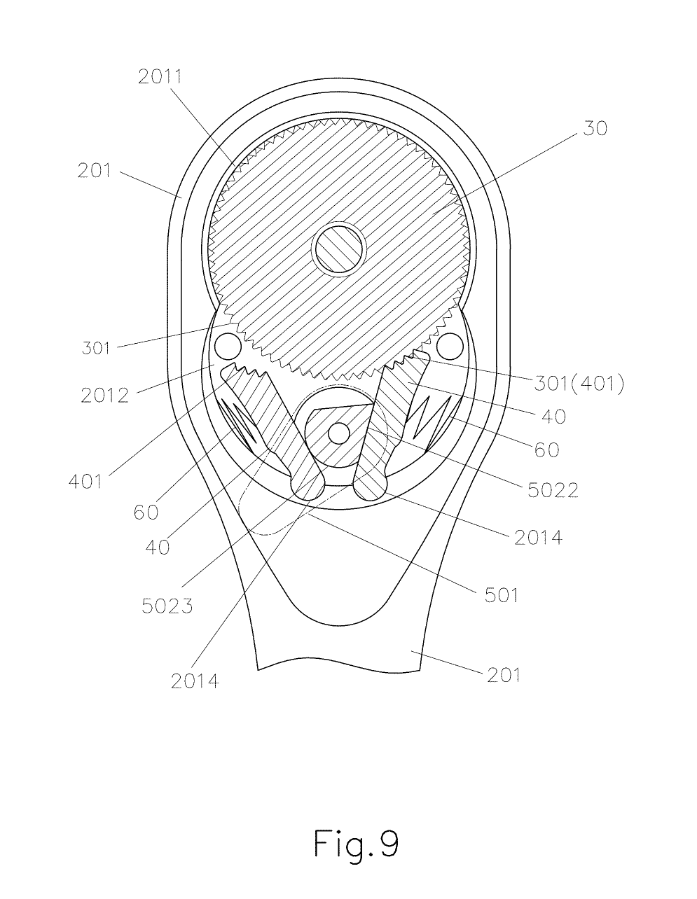

As shown in FIG. 6 to FIG. 10, a ratchet wrench in accordance with a first embodiment of the present invention comprise a main body 20, a ratchet 30, two detents 40, a switch knob 50, two elastic members 60, and a lid 70.

The main body 20 has a head portion 201 and a handle portion 202. The head portion 201 extends from one end of the handle portion 202. The head portion 201 has a first accommodation trough 2011 and a second accommodation trough 2012 communicating with the first accommodation trough 2011. The first accommodation trough 2011 and the second accommodation trough 2012 penetrate through two sides of the head portion 201. The first accommodation trough 2011 and the second accommodation trough 2012 have a connecting portion 2013 at one side of the head portion 201. The wall of the second accommodation trough 2012 is provided with a pair of pivot grooves 2014 opposite the first accommodation trough 2011. The other side of the head portion 201, opposite the connecting portion 2013, has an engaging groove 2015. The connecting portion 2013 is provided with two perforations 2016.

The ratchet 30 is disposed in the first accommodation trough 2011 of the main body 20. The periphery of the ratchet 30 is provided with a plurality of teeth 301. One end of the ratchet 30 has a coupling portion 302 for engaging with or disengaging from a socket (a conventional component, not shown).

The two detents 40 are arranged symmetrically left and right. The two detents 40 are disposed in the head portion 201 of the main body 20. The two detents 40 each have one end pivotally connected to the pair of pivot grooves 2014 of the main body 20 and another end formed with a toothed portion 401 corresponding to the teeth 301 of the ratchet 30.

The switch knob 50 is pivotally connected to the second accommodation trough 2012 of the main body 20 and is rotatable for selectively pushing one of the two detents 40 to disengage the toothed portion 401 of the detent 40 from the teeth 301 of the ratchet 30. The switch knob 50 has an operation portion 501 and a pillar portion 502. The pillar portion 502 extends vertically from one end of the operation portion 501. A cylindrical sleeve portion 503 is provided between the pillar portion 502 and the operation portion 501. The pillar portion 502 is substantially triangular in shape. The pillar portion 502 has a first side 5021, a second side 5022, and a contact side 5023. The contact side 5023 is connected between the first side 5021 and the second side 5022. The first side 5021 and the second side 5022 are disposed at an acute angle to the contact side 5023. The contact side 5023 is a curved side. A distal end of the pillar portion 502 is formed with a screw hole 504.

The two elastic members 60 each have one end leaning against the side wall surface of the second accommodation trough 2012 of the main body 20 and another end leaning against a corresponding one of the detents 40 for the toothed portion 401 of the detent 40 to mesh with the teeth 301 of the ratchet 30.

The lid 70 has a through hole 701 at one end thereof and a mounting hole 702 at another end thereof. Two screws 703 are inserted through the two perforations 2016 of the connecting portion 2013 and screwed to threaded holes 704 of the lid 70. The lid 70 is configured to cover the engaging groove 2015 to seal the aforesaid components in the head portion 201. The coupling portion 302 of the ratchet 30 is inserted through the through hole 701 and exposed to the outside. A bolt 705 is inserted through the mounting hole 702 and locked to the screw hole 504 of the switch knob 50 so that the switch knob 50 is positioned. An elastic washer 706 is provided between the engaging groove 2015 and the lid 70 so that the lid 70 is secured to the engaging groove 2015 tightly and won't be easily loosened.

The present invention is characterized in that the strength of the material of the two detents 40 is greater than that of the material of the ratchet 30.

Through the assembly of the above-described structure, the rotational direction of the ratchet 30 can be switched by turning the operation portion 501 of the switch knob 50. When the operation portion 501 is turned to the right, the left and right detents 40 are pushed by the contact side 5023 of the pillar portion 502. The right detent 40 is moved away from the ratchet 30 and the left detent 40 meshes with the ratchet 30, so that the ratchet 30 can be turned clockwise in a unidirectional direction. On the contrary, when the operation portion 501 is turned to the left, the left and right detents 40 are pushed by the contact side 5023 of the pillar portion 502. The right detent 40 meshes with the ratchet 30 and the left detent 40 is moved away from the ratchet 30, so that the ratchet 30 can be turned counterclockwise in a unidirectional direction.

Accordingly, the operator can switch the rotational direction of the ratchet 30 through the operation portion 501 of the switch knob 50. The coupling portion 302 of the ratchet 30 is used to engage with or disengage from a socket. The socket is used to fit a workpiece (not shown), so that the workpiece can be tightened or loosened by applying a force.

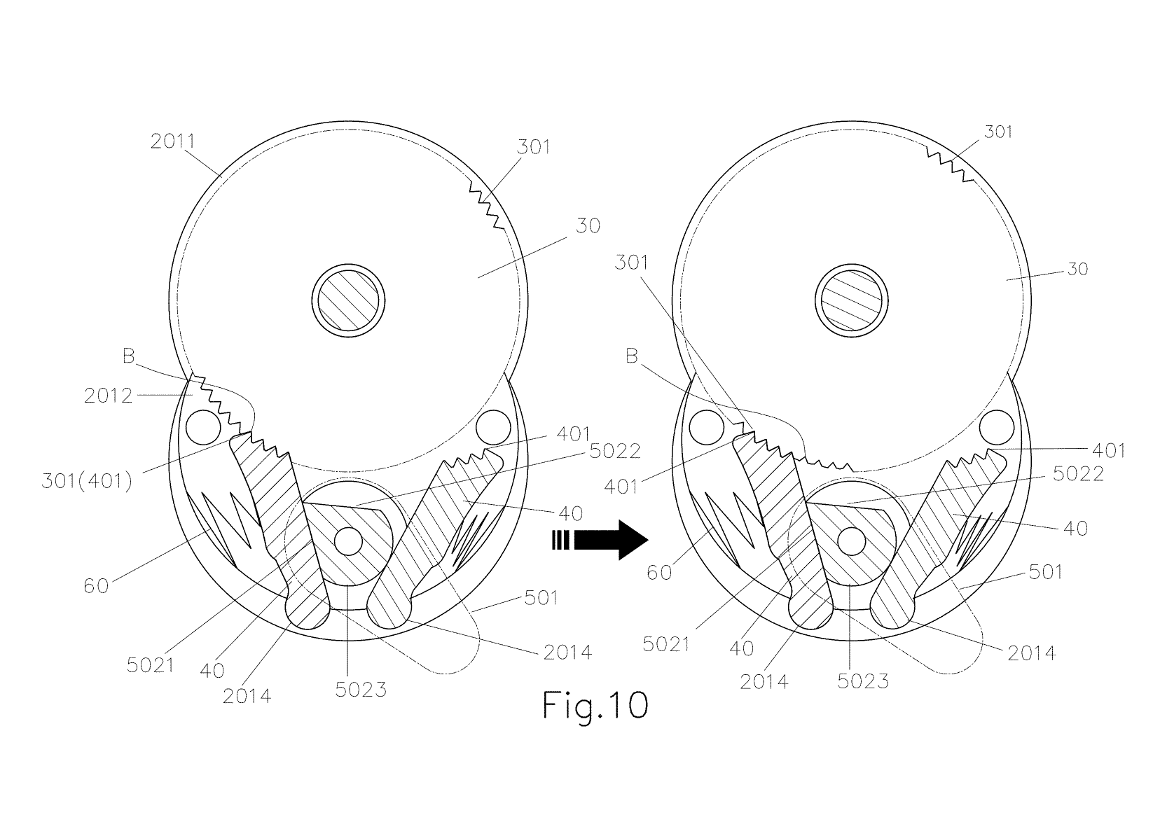

During the process of operating the ratchet wrench of the present invention, if the applied force is within the allowable range of the initial structural design of the ratchet wrench, the operation portion 501 of the switch knob 50 can be turned to switch the rotational direction of the ratchet 30 so that the teeth 301 of the ratchet 30 mesh with the tooth portion 401 of the left detent or the right detent 40, thereby enabling the coupling portion 302 of the ratchet 30 to engage with or disengage from a socket. The socket is used to fit a workpiece, so that the workpiece can be tightened or loosened by applying a force. As shown in FIG. 10, when the operator uses the ratchet wrench in cooperation with the socket to lock the workpiece, if the operator deems that the applied force is not enough to lock the workpiece and then applies a force greater than the limit torsional force of the meshing portion B between the teeth 301 of the ratchet 30 and the toothed portion 401 of the detent 40, the teeth will be damaged. Even if the number of the teeth of the toothed portion 401 of the detent 40 is obviously less than that of the teeth 301 of the ratchet 30, since the strength of the material of the detent 40 is greater than the strength of the material of the ratchet 30, the plurality of teeth 301 located at the meshing portion B of the ratchet 30 and the detent 40 will be damaged. When the toothed portion 401 of the detent 40 slips and the applied force loses the holding fulcrum on that moment, the toothed portion 401 of the detent 40 will be instantly engaged with the intact teeth 301 of the ratchet 30, located behind the damaged teeth, to be positioned again, thereby ensuring the safety of the operator.

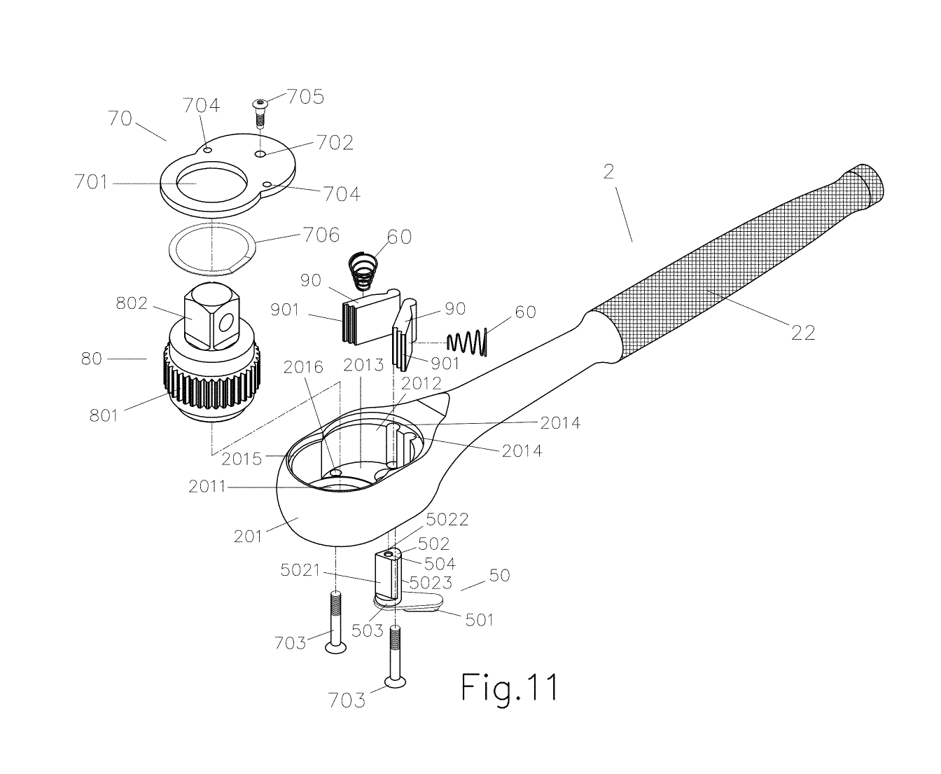

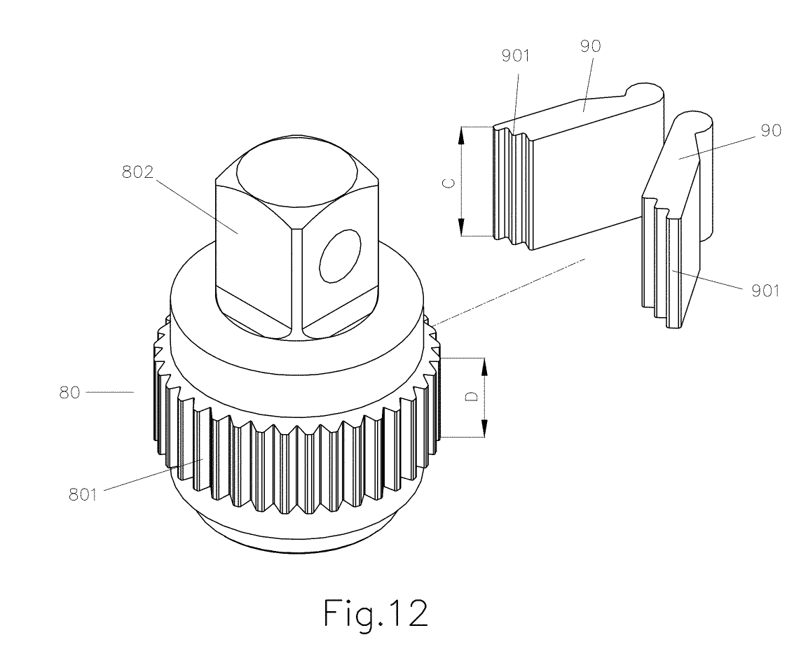

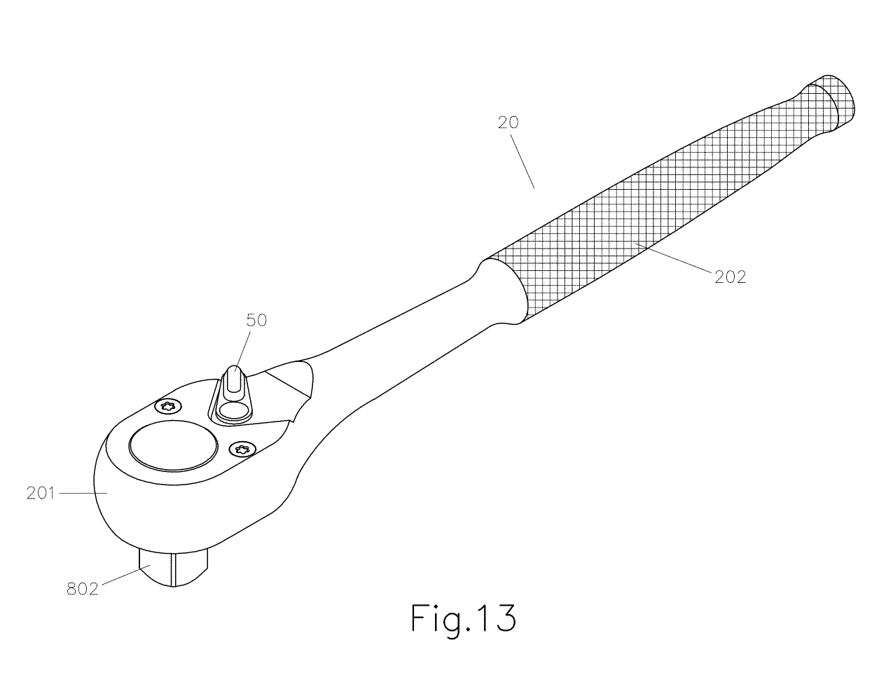

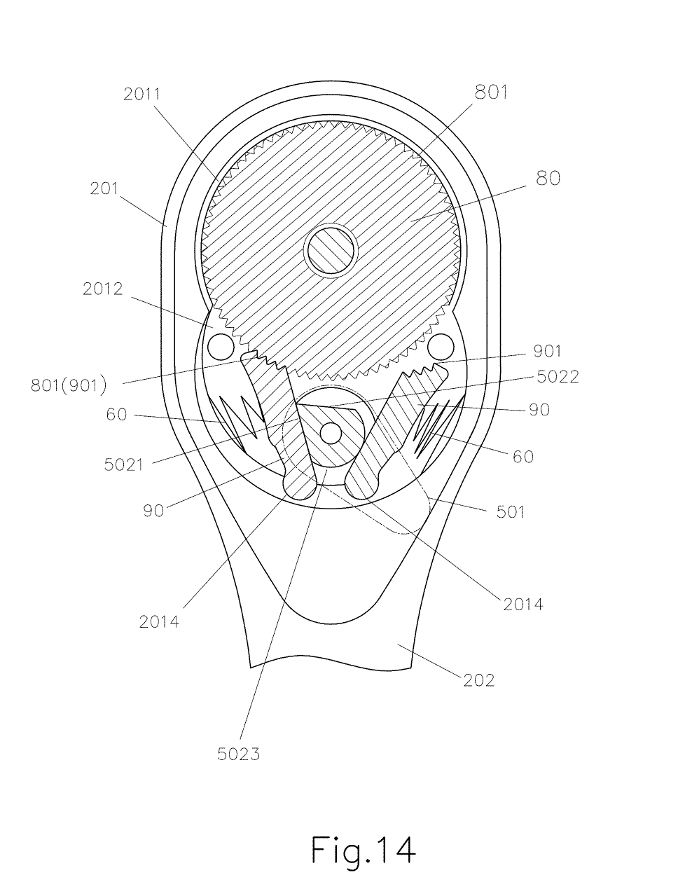

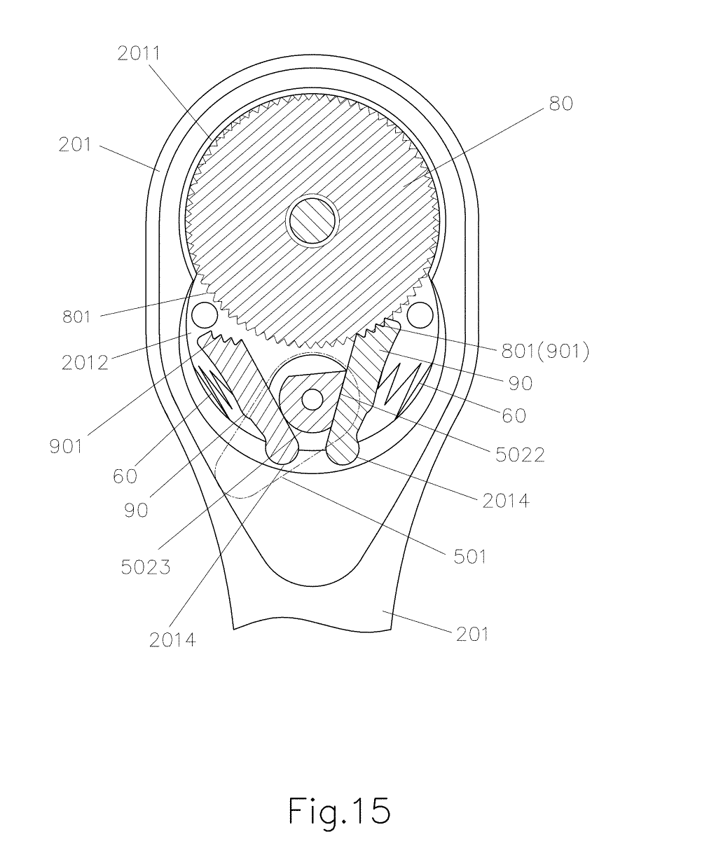

As shown in FIG. 11 to FIG. 16, a ratchet wrench in accordance with a second embodiment of the present invention comprise a main body 20, a ratchet 80, two detents 90, a switch knob 50, two elastic members 60, and a lid 70.

The main body 20 has a head portion 201 and a handle portion 202. The head portion 201 extends from one end of the handle portion 202. The head portion 201 has a first accommodation trough 2011 and a second accommodation trough 2012 communicating with the first accommodation trough 2011. The first accommodation trough 2011 and the second accommodation trough 2012 penetrate through two sides of the head portion 201. The first accommodation trough 2011 and the second accommodation trough 2012 have a connecting portion 2013 at one side of the head portion 201. The wall of the second accommodation trough 2012 is provided with a pair of pivot grooves 2014 opposite the first accommodation trough 2011. The other side of the head portion 201, opposite the connecting portion 2013, has an engaging groove 2015. The connecting portion 2013 is provided with two perforations 2016.

The ratchet 80 is disposed in the first accommodation trough 2011 of the main body 20 in a rotatable manner. The periphery of the ratchet 80 is provided with a plurality of teeth 801. One end of the ratchet 80 has a coupling portion 802 for engaging with or disengaging from a socket (a conventional component, not shown).

The two detents 90 are arranged symmetrically left and right. The two detents 90 are disposed in the head portion 201 of the main body 20. The two detents 90 each have one end pivotally connected to the pair of pivot grooves 2014 of the main body 20 and another end formed with a toothed portion 901 corresponding to the teeth 801 of the ratchet 80.

The switch knob 50 is pivotally connected to the second accommodation trough 2012 of the main body 20 and is rotatable for selectively pushing one of the two detents 90 to disengage the toothed portion 901 of the detent 90 from the teeth 801 of the ratchet 80. The switch knob 50 has an operation portion 501 and a pillar portion 502. The pillar portion 502 extends vertically from one end of the operation portion 501. A cylindrical sleeve portion 503 is provided between the pillar portion 502 and the operation portion 501. The pillar portion 502 is substantially triangular in shape. The pillar portion 502 has a first side 5021, a second side 5022, and a contact side 5023. The contact side 5023 is connected between the first side 5021 and the second side 5022. The first side 5021 and the second side 5022 are disposed at an acute angle to the contact side 5023. The contact side 5023 is a curved side. A distal end of the pillar portion 502 is formed with a screw hole 504.

The two elastic members 60 each have one end leaning against the side wall surface of the second accommodation trough 2012 of the main body 20 and another end leaning against a corresponding one of the detents 90 for the toothed portion 901 of the detent 90 to mesh with the teeth 801 of the ratchet 80.

The lid 70 has a through hole 701 at one end thereof and a mounting hole 702 at another end thereof. Two screws 703 are inserted through the two perforations 2016 of the connecting portion 2013 and screwed to threaded holes 704 of the lid 70. The lid 70 is configured to cover the engaging groove 2015 to seal the aforesaid components in the head portion 201. The coupling portion 802 of the ratchet 80 is inserted through the through hole 701 and exposed to the outside. A bolt 705 is inserted through the mounting hole 702 and locked to the screw hole 504 of the switch knob 50 so that the switch knob 50 is positioned. An elastic washer 706 is provided between the engaging groove 2015 and the lid 70 so that the lid 70 is secured to the engaging groove 2015 tightly and won't be easily loosened.

The present invention is characterized in that the face width C of the toothed portion 901 of each of the two detents 90 is greater than the face width D of the teeth 801 of the ratchet 80.

Through the assembly of the above-described structure, the rotational direction of the ratchet 80 can be switched by turning the operation portion 501 of the switch knob 50. When the operation portion 501 is turned to the right, the left and right detents 90 are pushed by the contact side 5023 of the pillar portion 502. The right detent 90 is moved away from the ratchet 80 and the left detent 90 meshes with the ratchet 80, so that the ratchet 80 can be turned clockwise in a unidirectional direction. On the contrary, when the operation portion 501 is turned to the left, the left and right detents 90 are pushed by the contact side 5023 of the pillar portion 502. The right detent 90 meshes with the ratchet 80 and the left detent 90 is moved away from the ratchet 80, so that the ratchet 80 can be turned counterclockwise in a unidirectional direction.

Accordingly, the operator can switch the rotational direction of the ratchet 80 through the operation portion 501 of the switch knob 50. The coupling portion 802 of the ratchet 80 is used to engage with or disengage from a socket. The socket is used to fit a workpiece (not shown), so that the workpiece can be tightened or loosened by applying a force.

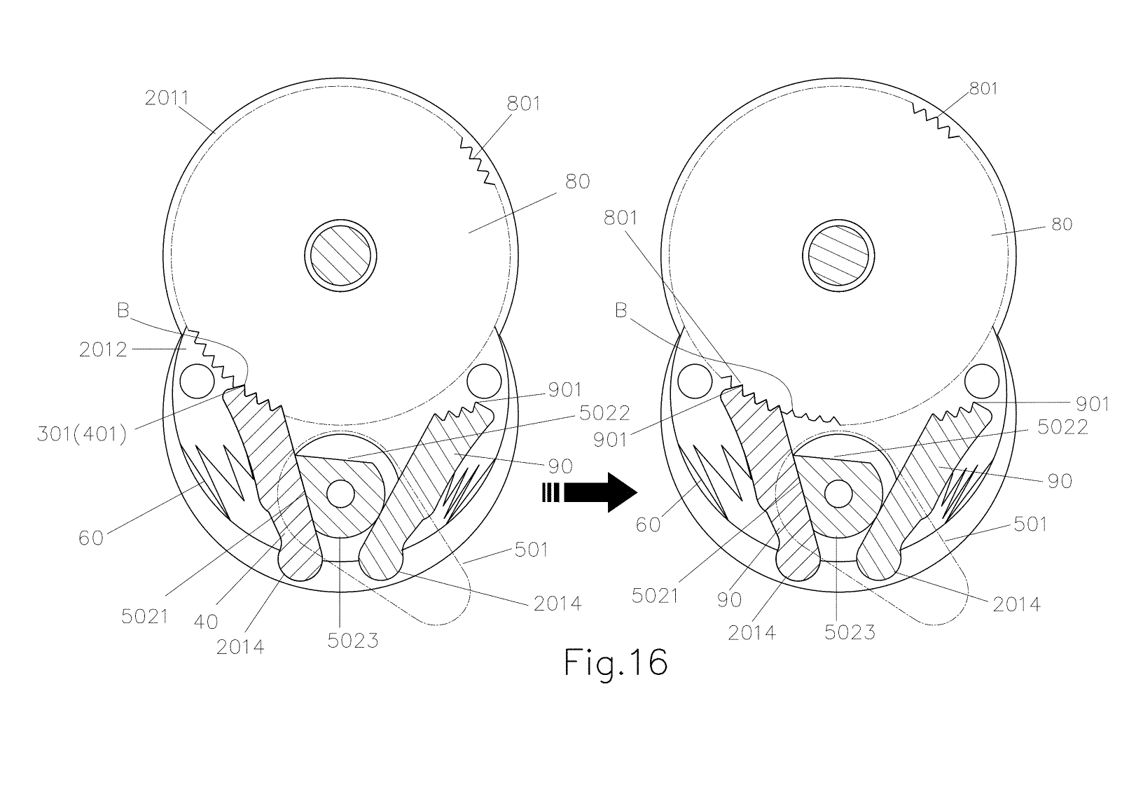

During the process of operating the ratchet wrench of the present invention, if the applied force is within the allowable range of the initial structural design of the ratchet wrench, the operation portion 501 of the switch knob 50 can be turned to switch the rotational direction of the ratchet 80 so that the teeth 801 of the ratchet 80 mesh with the tooth portion 901 of the left detent or the right detent 90, thereby enabling the coupling portion 802 of the ratchet 80 to engage with or disengage from a socket. The socket is used to fit a workpiece, so that the workpiece can be tightened or loosened by applying a force. As shown in FIG. 16, when the operator uses the ratchet wrench in cooperation with the socket to lock the workpiece, if the operator deems that the applied force is not enough to lock the workpiece and then applies a force greater than the limit torsional force of the meshing portion B between the teeth 801 of the ratchet 80 and the toothed portion 901 of the detent 90, the teeth will be damaged. Even if the number of the teeth of the toothed portion 901 of the detent 90 is obviously less than that of the teeth 801 of the ratchet 80, since the face width C of the toothed portion 901 of the detents 90 is greater than the face width D of the teeth 801 of the ratchet 80, the plurality of teeth 801 located at the meshing portion B of the ratchet 80 and the detent 90 will be damaged. When the toothed portion 901 of the detent 90 slips and the applied force loses the holding fulcrum on that moment, the toothed portion 901 of the detent 90 will be instantly engaged with the intact teeth 801 of the ratchet 80, located behind the damaged teeth, to be positioned again, thereby ensuring the safety of the operator.

Accordingly, the ratchet wrench of the present invention can ensure the safety of the operator if the operator applies a force greater than the limit torsional force of the meshing portion between the teeth of the ratchet and the toothed portion of the detent.

Although particular embodiments of the present invention have been described in detail for purposes of illustration, various modifications and enhancements may be made without departing from the spirit and scope of the present invention. Accordingly, the present invention is not to be limited except as by the appended claims.

What is claimed is:

1. A ratchet wrench, comprising:
a main body, having a head portion and a handle portion, the head portion extending from one end of the handle portion, the head portion having a first accommodation trough and a second accommodation trough communicating with the first accommodation trough, the first accommodation trough and the second accommodation trough penetrating through two sides of the head portion, the first accommodation trough and the second accommodation trough having a connecting portion at one side of the head portion, a wall of the second accommodation trough being provided with a pair of pivot grooves opposite the first accommodation trough, the other side of the head portion, opposite the connecting portion, having an engaging groove;
a ratchet, disposed in the first accommodation trough of the main body, a periphery of the ratchet being provided with a plurality of teeth, one end of the ratchet having a coupling portion;
two detents, arranged symmetrically left and right, the two detents being disposed in the head portion of the main body, the two detents each having one end pivotally connected to the pair of pivot grooves of the main body and another end formed with a toothed portion corresponding to the teeth of the ratchet;
a switch knob, pivotally connected to the second accommodation trough of the main body, the switch knob being rotatable for selectively pushing one of the two detents to disengage the toothed portion of the detent from the teeth of the ratchet;
two elastic members, the two elastic members each having one end leaning against a side wall surface of the second accommodation trough of the main body and another end leaning against a corresponding one of the detents for the toothed portion of the corresponding detent to mesh with the teeth of the ratchet;
a lid, having a through hole and screwed holes at one end, the lid being configured to cover the engaging groove of the main body so as to seal the aforesaid components in the head portion, the coupling portion of the ratchet being inserted through the through hole and exposed;
wherein the ratchet wrench is characterized in that the two detents are made of a material having a strength greater than that of a material of the ratchet.

2. The ratchet wrench as claimed in claim 1, wherein the connecting portion is provided with two perforations, and two screws are inserted through the two perforations of the connecting portion and screwed to the threaded holes of the lid for the lid to cover the engaging groove.

3. The ratchet wrench as claimed in claim 1, wherein an elastic washer is provided between the engaging groove of the head portion of the main body and the lid so that the lid is secured to the engaging groove tightly.

4. The ratchet wrench as claimed in claim 1, wherein the switch knob has an operation portion and a pillar portion, the pillar portion extends vertically from one end of the operation portion, a cylindrical sleeve portion is provided between the pillar portion and the operation portion, and a distal end of the pillar portion is formed with a screw hole.

5. The ratchet wrench as claimed in claim 4, wherein the pillar portion is substantially triangular in shape, the pillar portion has a first side, a second side and a contact side, the contact side is connected between the first side and the second side, the first side and the second side are disposed at an acute angle to the contact side, and the contact side is a curved side.

6. The ratchet wrench as claimed in claim 1, wherein the lid has a mounting hole at another end thereof, a bolt is inserted through the mounting hole and locked to the screw hole of the switch knob so that the switch knob is positioned.

7. The ratchet wrench as claimed in claim 4, wherein the lid has a mounting hole at another end thereof, a bolt is inserted through the mounting hole and locked to the screw hole of the switch knob so that the switch knob is positioned.

8. A ratchet wrench, comprising:
a main body, having a head portion and a handle portion, the head portion extending from one end of the handle portion, the head portion having a first accommodation trough and a second accommodation trough communicating with the first accommodation trough, the first accommodation trough and the second accommodation trough penetrating through two sides of the head portion, the first accommodation trough and the second accommodation trough having a connecting portion at one side of the head portion, a wall of the second accommodation trough being provided with a pair of pivot grooves opposite the first accommodation trough, the other side of the head portion, opposite the connecting portion, having an engaging groove;
a ratchet, disposed in the first accommodation trough of the main body, a periphery of the ratchet being provided with a plurality of teeth, one end of the ratchet having a coupling portion;
two detents, arranged symmetrically left and right, the two detents being disposed in the head portion of the main body, the two detents each having one end pivotally connected to the pair of pivot grooves of the main body and another end formed with a toothed portion corresponding to the teeth of the ratchet;
a switch knob, pivotally connected to the second accommodation trough of the main body, the switch knob being rotatable for selectively pushing one of the two detents to disengage the toothed portion of the detent from the teeth of the ratchet;
two elastic members, the two elastic members each having one end leaning against a side wall surface of the second accommodation trough of the main body and another end leaning against a corresponding one of the detents for the toothed portion of the corresponding detent to mesh with the teeth of the ratchet;
a lid, having a through hole and screwed holes at one end, the lid being configured to cover the engaging groove of the main body so as to seal the aforesaid components in the head portion, the coupling portion of the ratchet being inserted through the through hole and exposed;
wherein the ratchet wrench is characterized in that the toothed portion of each of the two detents has a face width greater than that of the teeth of the ratchet.

9. The ratchet wrench as claimed in claim 8, wherein the connecting portion of the main body is provided with two perforations, and two screws are inserted through the two perforations of the connecting portion and screwed to the threaded holes of the lid for the lid to cover the engaging groove.

10. The ratchet wrench as claimed in claim 8, wherein an elastic washer is provided between the engaging groove of the head portion of the main body and the lid so that the lid is secured to the engaging groove tightly.

11. The ratchet wrench as claimed in claim 8, wherein the switch knob has an operation portion and a pillar portion, the pillar portion extends vertically from one end of the operation portion, a cylindrical sleeve portion is provided between the pillar portion and the operation portion, and a distal end of the pillar portion is formed with a screw hole.

12. The ratchet wrench as claimed in claim 11, wherein the pillar portion is substantially triangular in shape, the pillar portion has a first side, a second side and a contact side, the contact side is connected between the first side and the second side, the first side and the second side are disposed at an acute angle to the contact side, and the contact side is a curved side.

13. The ratchet wrench as claimed in claim 8, wherein the lid has a mounting hole at another end thereof, a bolt is inserted through the mounting hole and locked to the screw hole of the switch knob so that the switch knob is positioned.

14. The ratchet wrench as claimed in claim 11, wherein the lid has a mounting hole at another end thereof, a bolt is inserted through the mounting hole and locked to the screw hole of the switch knob so that the switch knob is positioned.
